(19) United States
(12) Patent Application Publication
(10) Pub. No.: US 2007/0247320 A1
(43) Pub. Date: Oct. 25, 2007

(54) Proximity purpose device and system

(76) Inventor: Robert J. Morahan, Simpsonville, SC (US)

Correspondence Address: NEXSEN PRUET, LLC, P.O. BOX 10648, GREENVILLE, SC, 29603, US

(21) Appl. No.: 11/787,745

(22) Filed: Apr. 17, 2007

Related U.S. Application Data
(60) Provisional application No. 60/792,535, filed on Apr. 17, 2006.

(51) Int. Cl. G08B 23/00; G08B 21/00

(52) U.S. Cl. 340/573.1; 340/686.6

(57) ABSTRACT

A proximity-purpose device and system that recognizes the reason a user is in its proximity and helps the user set and record actions consistent with his or her purpose for being near it. In particular, the device must include a proximity detector, a user interface and a purpose engine.

### CROSS REFERENCE TO RELATED APPLICATIONS

Not Applicable.

### STATEMENT REGARDING FEDERALLY SPONSORED RESEARCH OR DEVELOPMENT

Not applicable.

### REFERENCE TO A SEQUENCE LISTING, A TABLE, OR A COMPUTER PROGRAM LISTING COMPACT DISK APPENDIX

Not Applicable.

### BACKGROUND OF THE INVENTION

The present invention relates generally to devices for managing and distributing information.

Both in personal and professional settings, there is a need to manage and access relevant information quickly and simply. Whereas many information technology devices exist to simplify everyday life, these devices typically encompass a broad range of information, and the user must navigate and organize the information in a format that is suitable for the user.

Thus far, the use of purpose-driven devices are not available. Through the use of a device that could recognize the purpose for which it is accessed or approached, the ease and efficiency of managing specific information becomes greatly enhanced.

### SUMMARY OF THE INVENTION

The following presents a simplified summary of the invention in order to provide a basic understanding of some aspects of the invention. This summary is not an extensive overview of the invention. It is not intended to identify key or critical elements of the invention or to delineate the scope of the invention. Its sole purpose is to present some concepts of the invention in a simplified form as a prelude to the more detailed description that is presented later.

The present invention includes a proximity-purpose device and system that recognizes the reason a user is in its proximity and helps the user set and record actions consistent with his or her purpose for being near it. In particular, the device must include a proximity detector, a user interface and a purpose engine.

In particular, system allows users to manage specific purpose information from any internet access point and then access that information, by automatic or manual individual identification, at specific places (outlets) in proximity to where that information will be pertinent. Additionally, the system allows for creation and modification of outlet specific information that will then be made accessible from any internet access point. The system allows users to grant accessibility of any or all of that information to any other registered user.

Other features and advantages of the present invention will be apparent to those skilled in the art from a careful reading of the Detailed Description of the Invention presented below and accompanied by the drawing.

### BRIEF DESCRIPTION OF THE DRAWINGS

In the drawings,

FIG. 1 illustrates a flow diagram of the process of the present invention according to a preferred embodiment;

FIG. 2 illustrates a flow diagram of the process of the present invention according to a preferred embodiment.

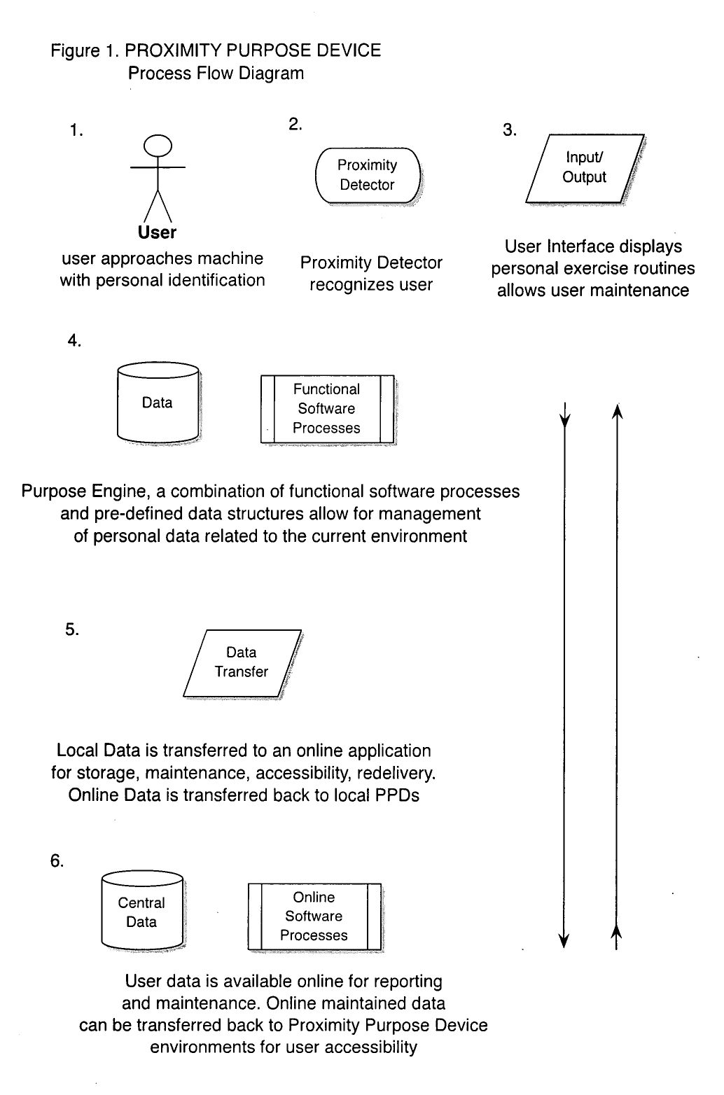

### DETAILED DESCRIPTION OF THE INVENTION

The proximity-purpose device and system of the present invention recognizes the reason a person is in its proximity and helps the person set and record actions consistent with his or her personal purpose for being near it. The device includes a series of local devices networked to a centralized system that houses, delivers and tracks the purposes and progress of the person using it.

The device and/or system is novel in that it requires the planning and execution of tasks that can help a person achieve a desired outcome by understanding the purpose of the person's attendance at a specific proximity-purpose point-of-contact, herein referred to as an Action Node. The device is novel in that it requires a person to interact with it to set Actions appropriate to the proximate situation and report the completion of the Actions in support of his or her goals.

As shown in the drawing, the device and system includes a Proximity Detector, a User Interface and a Purpose Engine. The purpose of the Proximity Detector is to determine the identity of the person at the Action Node. The proximity detector in the working model of the invention consists of a radio frequency identification (RFID) tag and receiver, although other technologies such as palm print, retinal scan or audio-processing could also be used. The purpose of the User Interface is to allow a person the ability to set and record Actions at the proximate Action Node. In the working model, the User Interface consists of a touch-screen computer monitor, although audio and other types of hardware or interfaces could also be used. The purpose of the Purpose Engine is to understand the identity of the person at a specific Action Node and collect and deliver information to the person on specific Actions appropriate for the Action Node. The Purpose Engine in the working model consists of a centralized database utilizing hardware, software and networking technologies in concert with the Action Nodes.

For an example of how the proximity-purpose device operates, the working model helps a person achieve personal fitness goals. Instead of using a manual pencil and paper method to track progress, the person wears an RFID tag in proximity to a touch-screen Action Node at a gym and then sets and records Actions consistent with the purpose of the workout regimen. The proximity-purpose device can help any person near an Action Node achieve a purpose consistent with the situation at the Action Node. The proximity-purpose device can help parents and teachers of children in early education understand progress, for instance, in working with and mastering manipulatives. Likewise, The proximity-purpose device can help patients and therapists in recovery centers through a rehabilitation regimen. The proximity-purpose device is novel because it allows a person in proximity to an Action Node to set and record actions consistent with his or her personal purpose for being near it.

The proximity-purpose device is different than geographic locating tools because the spatial location of the person at an Action Node is irrelevant and because it relies on the affirmative interaction of the person to set and record Actions. The proximity-purpose device is different than other automated tracking systems for the same reason—while the Proximity Detector recognizes the person visiting and knows the reason for the visit, the Purpose Engine allows the person, through the User Interface, to set and record Actions toward a purpose consistent with the reason for the visit. The proximity-purpose device is different than personal productivity software because it allows the person to set intended actions and then recognizes when and why they are present at an environment-specific Action Node. In short, the invention of the proximity-purpose Machine allows a person to set and record actions consistent with his or her personal purpose for being in the environment where it is located.

The following includes an outline of an embodiment of the present invention:

Internet Application

Software Application designed for specific outlet or type of outlet.
Application manages users, outlets, and purpose information.
Application provides user access/maintenance to personal or assigned information.
Application also manages sponsor directed information and access algorithms.
   Proximity Purpose Application (PPA)
Software Application designed for use at a specific outlet or a range of outlets.
Local application manages access to/maintenance of user's information relative to the proximate environment.
   Communication Device
Communication device will provide a link between the Internet Application data and Proximity Purpose Application data. These communications may be scheduled or generated in real time.
   Data Transfer Application
Software Application designed to transfer new or updated information between Internet Application and Proximity Purpose Application.
   Automatic Identification Device
An automatic identification device, that may be carried, worn, or otherwise attached to the user, will be readable by outlet Proximity Purpose Machines.
The automatic identification of a user will automatically cause the Proximity Purpose Application to present user/assignee/sponsor proximate environment related information to the identified user.
   Manual User Identification
Optionally, manual access to the Proximity Purpose Application, through machine log in, may be provided, where appropriate.
   Proximity Purpose Machines (PPM)
Machine consisting of Computer System, Automatic User Identification Device, Communication device, and Proximity Purpose Application, as a whole, providing user access to tools and information useful in its proximate environment.

The following are examples of the proximity-purpose device applications.

1. Initial Application—Touchtrak
Touchtrak can be the first Proximity Purpose Device System to be developed and deployed.
Touchtrak can allow users to maintain and track personal fitness information by using the PPMS online and at health clubs (outlet).
   Touchtrak Overview
   Internet Application Component
Users log in to an internet application that allows them to create/maintain personal fitness routines, goals, and related information.
The application lets users grant access to fitness trainers to work with that information.
Personal information gathered from PPM is made available through reports and various screen views.
   Proximity Purpose Device
A Proximity Purpose Device is installed at a local health club. This device can include the following components:
   Computer System
      Kiosk Cabinet
      Touchscreen Monitor
      Operational Hardware (Motherboard/Harddrive/etc . . . )
      Operating Software (Operating System/Database/Browser)
      Radio Frequency Identification Reader
   Communication Device
      Wireless Modem Card, accessing a VPN (virtual private network) through a wireless provider like Sprint or Verizon.
   Automatic Identification Device
      Passive, Read-only RFID Tag worn by users such as on the users' shoe.
      The Tag has an imbedded chip with a 10 digit number (stored as hexidecimal), providing one of approximately 10 billion unique combinations.
   Proximity Purpose Application
      Custom Designed software can allow user to access personal information (see detailed description in this section).
         Proximity Purpose Application
This application gathers the RFID hexidecimal tag value, converts it to numeric, then compares this to the database of users.
If a user exists, he/she is immediately presented with a User Interface that automatically provides access to their personal information and system content about Workout Routines that the user may want to perform. Unrecognized users/non-members (i.e. tag number is not in the system) are also immediately identified and are presented with a means to set up a new account.
   Data Transfer Application
An extract module can be designed to pull new/revised data from the proximity purpose device.
   Communication Device
A wireless modem is used to contact the Touchtrak Internet server to update the central database with PPA maintained information extracted through the Data Transfer Application.
   Automatic Identification Device
As defined above, a Passive, Read-only RFID Tag worn on the users shoe. The Tag has an imbedded chip with a 10 digit number (stored as hexidecimal), providing one of approximately 10 billion unique combinations.
   2. Examples of Other Possible Applications

Other applications could include:
Grocery Stores
   Any/All family members maintain grocery list in Internet Application.
   All family members have assignee/assignor access
   When they go to the store, a proximity purpose device is used to access the list of everything the family needs (not just the individual members stuff).
   The proximity purpose device orders the list by aisle (to simplify and speed up shopping).
   The proximity purpose device also custom delivers sponsor coupons based on listed prospective purchases or history.
New Construction
   Central purchasers build daily, job, or other specific materials lists and assign these to workers who will pick up the materials.
   The worker, who wears an rfid tag, approachs the PPM, which recognizes the worker, accesses the internet application, then automatically generates the list of required materials.
Child Care
   Read/Write PPM are setup at activity stations, so that a childs daily activities (activity/time spent/etc) are recorded during the day. These are made accessible to parents/assigned caregivers through the internet portion of the application.

1. A device, comprising:
a proximity detector;
a user interface;
an action node; and
a purpose engine, wherein said device recognizes the reason a person is in a place, delivers useful information to people by recognizing why they are in a specific place, and allows a choice of action consistent with the reason a person is in a place.

2. The device as recited in claim 1, wherein said device within a gym or health club environment recognizes users who are in close proximity, allows users to automatically retrieve their personal exercise routines and related data, allows the user to maintain their personal data related to actual exercises and workouts, and manages that data for future accessibility and use.
